(19) United States
(12) Patent Application Publication
(10) Pub. No.: US 2002/0129471 A1
(43) Pub. Date: Sep. 19, 2002

(54) Wire lock

(76) Inventor: Chin-Yang Wang, Taipei Hsien (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 09/832,862

(22) Filed: Apr. 12, 2001

(30) Foreign Application Priority Data
Mar. 14, 2001 (TW) 90203773

(51) Int. Cl. F16L 33/00

(52) U.S. Cl. 24/601.2; 24/16 PB

(57) ABSTRACT

An integral piece of wire lock comprises a lock part, a rear part, and a facial part. The lock part provides an upper end extending an inward locking tenon. The rear part has an end thereof is provided with a bend to join the lock part, and another end thereof is provided with another bend. A facial part is formed by way of extending forward from said another bend on the rear part with an end extending toward the locking part, and an inner wall surface provides a wall recess. The facial part can be pressed to engage with the locking part such that the wall recess can sliadably receive an elongated strip material and the space between the facial part and the rear part can slidably receive at least another elongated strip material.

### BACKGROUND OF THE INVENTION

1. Field of The Invention

The present invention relates to a wire lock, and particularly to a wire lock, which can clip different wires separately and orderly.

2. Description of Related Art

Elongated strip material such as an electric wire, hanging cord, and etc. are frequently used in our daily life. For instance, some peoples, especially some women, like to hang the popularly used cellular phone while they carry about the cellular phone with them. Usually, the cellular phone is hung in front of the chest by way of a flat nylon cloth or a round tying belt effectively.

However, the occasion we use the cellular phone is not simply at home or in the office that the cellular phone can be held during making or receiving a phone. Instead, a hold-free receiver such as an external earphone with a microphone is often used and the external device at least has two connection lines. Of course, these two connecting lines are usually joined integrally as a flat shape.

Under this circumstance, the hanging cord and the connecting lines may tangle with each other and it will become a mess and more tangled in front of the chest if a hung personal identification badge is added.

### SUMMARY OF THE INVENTION

An object of the present invention is to provide a wire lock, which is possible to movably locate at least two elongated strip materials separately in order.

### BRIEF DESCRIPTION OF THE DRAWINGS

The present invention can be more fully understood by referring to the following description and accompanying drawings, in which:

FIG. 1 is a perspective view of a wire lock according to the present invention;

FIG. 2 is a perspective view illustrating an embodiment of the present invention; and

FIG. 3 is a perspective view illustrating another embodiment of the present invention.

### DETAILED DESCRIPTION OF THE PREFERRED EMBODIMENTS

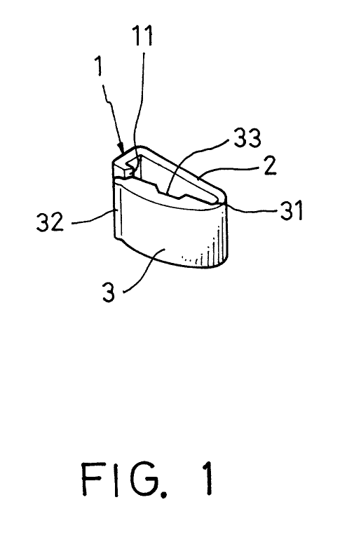

Referring to FIG. 1, a wire lock of present invention basically is made of high molecular material or metallic material, and comprises a lock part 1, a rear part 2 and a facial part 3.

Wherein, the lock part 1 is an extended bend from the rear part 2, and although the bend shown in FIG. 1 is rectangular, it does not mean that the bend has to be a right angle. Also, the bend at the upper end thereof extends inward a locking tenon 11 with a downward slant for engaging with the facial part 3.

The facial part 3 at an end thereof joins the rear part 2 and preferably provides a slight curved shape but not required. As shown in FIG. 1, the facial part 3 is constituted by way of the rear part 2 extending forward a facial turn 31 first and then extending toward the locking tenon 11. The facial part 3 at an end thereof provides a facial projection end 32 and the facial projection end 32 has an inner slant preferably but not required. The facial part 3 at the inner wall surface thereof provides a wall recess 33 for receiving wires.

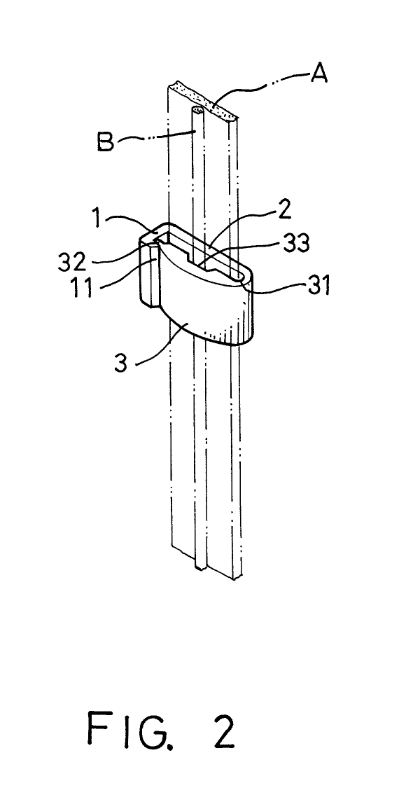

Referring to FIG. 2, an example is illustrated for the wire lock of present invention being applied to a cellular phone with a held-free receiver. First, a flat hanging belt A is disposed over the rear part 2 and a signal wire B is placed on the hanging belt A. Then, press the facial part 3 downward such that the facial projection end 32 can be kept blocked by the locking tenon 11 without loosening so as to form the flat hanging belt A and the signal wire B being retained separately. That is, the signal wire B is received in the wall recess 33 and the hanging belt A being received in a room between the facial part 3 and the rear part 2 under a condition of the hanging belt A and the signal wire being possible to be slid synchronously.

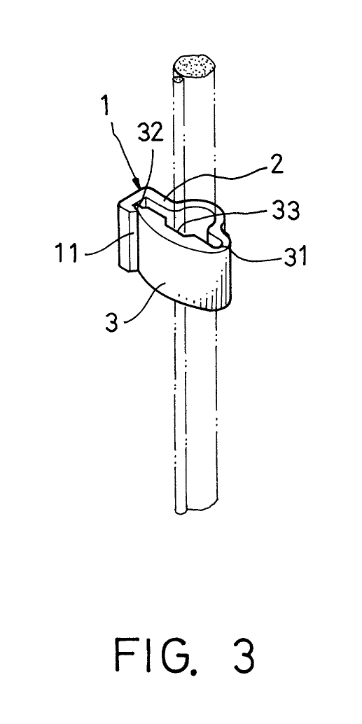

Referring to FIG. 3, another example for the application of present invention is illustrated and it can be seen that an increased space is arranged between the facial part 3 and the rear part 2 for receiving a thicker belt or a larger sized wire. Because the examples shown in FIGS. 2 and 3 are equivalent embodiments, no further detail will be described for the illustration of FIG. 3.

It is appreciated that the wire lock provided by the present invention is possible to slidably retain two or more different elongated strip materials and is a great breakthrough of wire lock comparing to the conventional metal clip.

While the invention has been described with reference to preferred embodiments thereof, it is to be understood that modifications or variations may be easily made without departing from the spirit of this invention, which is defined by the appended claims.

What is claimed is:

1. An integral piece of wire lock, comprising
a lock part, providing an upper end extending inward a locking tenon;
a rear part with two ends, an end thereof being provided with a bend to join the lock part, and another end thereof being provided with another bend; and
a facial part with an end, being formed by way of extending forward from said another bend on the rear part with the end extending toward the locking part, and an inner wall surface providing a wall recess;
whereby, the facial part can be pressed to engage with the locking part such that the wall recess can slidably receive an elongated strip material and the space between the facial part and the rear part can slidably receive another elongated strip material.

2. The wire lock according to claim 1 is integrally made of flexible material.

3. The wire lock according to claim 1, wherein the facial part at the end thereof may be provided with a facial projection end.

4. The wire lock according to claim 1, wherein said locking part provides a slant and the facial projection end provides another slant same as the slant on the locking part.

5. The wire lock according to claim 1, wherein a gap is formed between said facial part and the rear part.

6. The wire lock according to claim 1, wherein the facial part provides a minor curved shape.
